(19) United States
(12) Patent Application Publication
(10) Pub. No.: US 2025/0342349 A1
(43) Pub. Date: Nov. 6, 2025

(54) METHOD FOR ASSESSING MODEL UNCERTAINTIES BY MEANS OF A NEURAL NETWORK, AND AN ARCHITECTURE OF THE NEURAL NETWORK

(71) Applicant: Robert Bosch GmbH, Stuttgart (DE)

(72) Inventors: Gerhard Neumann, Karlsruhe (DE); Michael Volpp, Stuttgart (DE)

(21) Appl. No.: 18/870,736

(22) PCT Filed: Jun. 14, 2023
(86) PCT No.: PCT/EP2023/065902

§ 371 Date: Dec. 2, 2024

(30) Foreign Application Priority Data
Jun. 29, 2022 (DE) 10 2022 206 629.4

(51) Int. Cl. G06N 3/047; G06N 3/0455; G06N 3/0985

(52) U.S. Cl. CPC G06N 3/047; G06N 3/0455; G06N 3/0985

(57) ABSTRACT

A computer-implemented method for assessing uncertainties using a neural network, in particular a neural process, in a model, The model models a technical system and/or system behavior of the technical system. An architecture of the neural network for assessing uncertainties is also described.

### FIELD

The present invention relates to a method for assessing uncertainties using a neural network and to an architecture of the neural network.

### SUMMARY

In technical systems, in particular safety-critical technical systems, models, in particular models for active learning, reinforcement learning, or extrapolation, can be used to predict uncertainties, for example by means of neural networks.

Recently, neural processes have been increasingly used to predict model uncertainties. Neural processes are essentially a family of neural-network-based architectures that produce probabilistic predictions for regression problems. They automatically learn inductive biases tailored to a class of target functions with some kind of common structure, for example quadratic functions or dynamics models of a particular physical system with varying parameters. Neural processes are trained using so-called multi-task training methods, wherein one function corresponds to one task. The resulting model provides accurate predictions about unknown target functions on the basis of only a few context observations.

A so-called aggregation mechanism is used to feed the context observations into the architecture. Such a mechanism allows one context tuple, i.e., an input-output pair (x, y) from the target function, at a time to be passed through an encoder network that maps each context tuple to a latent observation r. All latent observations are subsequently aggregated by a kind of contraction operation. Traditionally, neural processes use mean aggregation, i.e., the aggregation mechanism takes the mean over all latent observations. It is also conventional to use Bayesian context aggregation in neural processes. In contrast to mean aggregation, which assigns a uniform weighting of 1/N to all latent observations, where N is the size of the context set, Bayesian context aggregation allows weighting of the latent observations according to a learned measure of the ambiguity of the task. This is relevant since different context tuples contain different amounts of information about the identity of the target function. If the context tuple is located in a region of the xy-space with high task ambiguity, i.e., it could be generated by many functions from the underlying function class, the amount of information conveyed by this context tuple is low. The weight of the corresponding latent observation in the aggregated set must therefore also be low and, conversely, if the amount of information is high, the weight must also be high. In Bayesian context aggregation, task-ambiguity-dependent weighting is achieved by adding a second encoder network. The second encoder network learns to quantify the task ambiguity of each context tuple through the variance of the latent observation. This encoder output then modulates the weight of the corresponding latent observation according to a Bayesian observation model. In principle, experimental results show that Bayesian context aggregation improves the predictive performance of neural processes in comparison with traditional mean aggregation.

An object of the present invention is to provide a method and an architecture that can at least maintain or improve the predictive performance of Bayesian context aggregation and the advantages, such as the uneven weighting of the latent observations in the aggregation, and at the same time are more parameter-efficient than Bayesian context aggregation.

### SUMMARY

This object may be achieved by a method according to the described example embodiments of the present invention.

One example embodiment of the present invention relates to a computer-implemented method for assessing uncertainties by means of a neural network, in particular a neural process, in a model, wherein the model models a technical system and/or system behavior of the technical system, wherein a model uncertainty σ_{z}² as the variance of a latent Gaussian distribution and a mean μ_{z} of the latent Gaussian distribution are determined on the basis of a number N of latent observations rₙ, with n=1 . . . N, in one step, wherein the model uncertainty σ_{z}² and the mean μ_{z} are determined depending on the latent observations rₙ and a hyperparameter T, and the latent Gaussian distribution is parameterized by the variance σ_{z}² and the mean μ_{z} in a further step. It should be noted that the model was created on the basis of measurements of the technical system.

The introduction of the hyperparameter T, also known as softmax temperature, allows for uneven weighting of the latent observations but does not require a second encoder network. The use of the additional trainable hyperparameter makes so-called softmax aggregation possible, which can replace conventional aggregation methods, such as mean aggregation, max aggregation, or Bayesian aggregation, in neural-process-based architectures.

The softmax aggregation described according to the disclosure greatly simplifies the above-described Bayesian aggregation in that the softmax aggregation stipulates a fixed dependence of the variances

$${σ}_{{r}_{n}}^{2}$$

of the latent observations on the latent observations rₙ as follows:

$${σ}_{{r}_{n}}^{2} := exp ( - \frac{{r}_{n}}{T} )$$

This means that no separate encoder network is required to calculate

$${σ}_{{r}_{n}}^{2} .$$

This reduces the number of parameters to be learned.

The fixed dependence of the variances

$${σ}_{{r}_{n}}^{2}$$

on the latent observations rₙ and the hyperparameter T can be used in the conventional Bayesian aggregation equations. The resulting equations then form the softmax aggregation equations:

$${σ}_{z}^{2} = \frac{1}{{\sum }_{n = 1}^{N} exp ( \frac{{r}_{n}}{T} )}$$

$${μ}_{z} = \frac{{\sum }_{n = 1}^{N} {r}_{n} \cdot exp ( \frac{{r}_{n}}{T} )}{{\sum }_{n = 1}^{N} exp ( \frac{{r}_{n}}{T} )}$$

According to one example embodiment of the present invention, the latent observations rₙ are generated by mapping context data pairs xₙ,yₙ to a corresponding latent observation rₙ by means of a neural encoder network. Subsequently, σ_{z}² and μ_{z} are calculated according to the described equations and the latent Gaussian distribution is parameterized with these parameters.

It may be provided that the hyperparameter T is generated by means of the neural encoder network in order to map the context data pairs xₙ,yₙ.

For example, it may be advantageous if the hyperparameter T is learned together with parameters of the neural encoder network in order to map the context data pairs xₙ, yₙ, for example in a common learning process.

According to a further example embodiment of the present invention, the hyperparameter T is determined independently through hyperparameter optimization.

According to a further example embodiment of the present invention, a variance of an output of the model, also output variance σ_{y}², is determined on the basis of the latent Gaussian distribution, in particular on the basis of an input point x and on the basis of a latent sample z derived from the Gaussian distribution, by means of a neural decoder network. The neural decoder network can thus calculate predictions about target variables y at locations x on the basis of samples z from the latent Gaussian distribution.

According to a further example embodiment of the present invention, a mean μ_{y} of the output of the model is determined on the basis of the latent Gaussian distribution, in particular on the basis of an input point x and on the basis of a latent sample z derived from the Gaussian distribution, by means of a further neural decoder network. The mean μ_{y}, in particular in combination with the output variance, provides an estimate of target variables y.

Further example embodiments of the present invention relate to an architecture of a neural network, in particular of a neural process, wherein the neural network is designed to perform steps of a method according to the described embodiments for assessing uncertainties in a model, wherein the model models a technical system and/or system behavior of the technical system.

According to one example embodiment of the present invention, the neural network comprises at least one neural encoder network and/or at least one neural decoder network, wherein the neural encoder network is trained to generate latent observations rₙ on the basis of context data pairs xₙ, yₙ, and/or wherein the neural decoder network is trained to determine a variance of an output of the model, also output variance σ_{y}², and/or a mean μ_{y} of the output of the model on the basis of the latent Gaussian distribution.

Further example embodiments of the present invention relate to a device comprising a neural network, in particular a neural process, with an architecture according to the described embodiments, wherein the device is designed to perform steps of a method according to the described embodiments.

Further example embodiments of the present invention relate to a use of a method according to the described embodiments and/or of a neural network, in particular of a neural process, with an architecture according to the described embodiments, for ascertaining an in particular impermissible deviation of system behavior of a technical system from a standard value range. It should be noted that the technical system can be switched to a safe operating mode or a warning can be issued depending on an ascertained deviation.

An artificial neural network supplied with input data and output data of the technical device in a learning phase is useful when ascertaining the deviation of the technical system. Through the comparison with the input data and output data of the technical system, the corresponding connections are created in the artificial neural network and the neural network is trained on the system behavior of the technical system.

According to an example embodiment of the present invention, in a prediction phase following the learning phase, the system behavior of the technical system can be reliably predicted by means of the neural network. For this purpose, in the prediction phase, input data of the technical system are supplied to the neural network, and output comparison data are calculated in the neural network and are compared with output data of the technical system. If this comparison between the output data of the technical system, which are preferably recorded as measured values, deviate from the output comparison data of the neural network and the deviation exceeds a limit value, there is an impermissible deviation of the system behavior of the technical system from the standard value range. Appropriate measures can then be taken, for example a warning signal can be generated or stored or partial functions of the technical system can be deactivated (degradation of the technical device). If necessary, alternative technical devices may be used in the event of an impermissible deviation.

Using the method described above, a real technical system can be continuously monitored. During the learning phase, the neural network is fed with sufficient information about the technical system from both the input side and the output side thereof, so that the technical system can be mapped and simulated in the neural network with sufficient accuracy. This makes it possible in the subsequent prediction phase to monitor the technical system and to predict a deterioration in the system behavior. In this way, the remaining service life of the technical system can in particular be predicted.

Further features, possible applications, and advantages of the present invention become apparent from the following description of exemplary embodiments of the present invention shown in the figures. All described or depicted features by themselves or in any combination constitute the subject matter of the present invention, regardless of their formulation or representation in the description or in the figures.

### BRIEF DESCRIPTION OF THE DRAWINGS

FIG. 1 schematically shows a method for assessing uncertainties according to one example embodiment of the present invention.

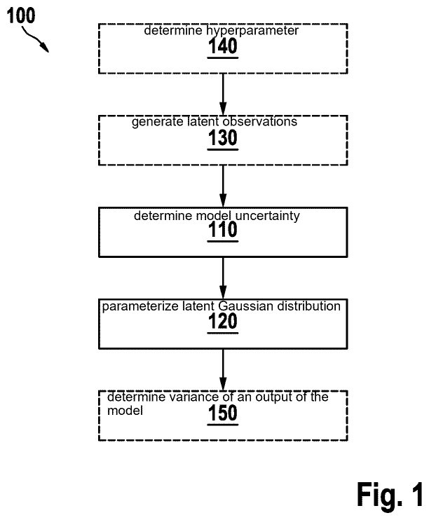

FIG. 2 shows an architecture of a neural process according to one example embodiment of the present invention.

### DETAILED DESCRIPTION OF EXAMPLE EMBODIMENTS

In the following, a computer-implemented method for assessing uncertainties by means of a neural network, in particular a neural process, in a model, wherein the model models a technical system and/or system behavior of the technical system, is described with reference to the figures.

The method 100 comprises a step 110, wherein a model uncertainty σ_{z}² as the variance of a latent Gaussian distribution and a mean μ_{z} of the latent Gaussian distribution are determined on the basis of a number N of latent observations rₙ, with n=1 . . . N, in step 110, wherein the model uncertainty σ_{z}² and the mean μ_{z} are determined depending on the latent observations rₙ and a hyperparameter T.

The dependence of the variances

$${σ}_{{r}_{n}}^{2}$$

of the latent observations on the latent observations rₙ and the hyperparameter T is stipulated as follows:

$${σ}_{{r}_{n}}^{2} := exp ( - \frac{{r}_{n}}{T} )$$

The fixed dependence of the variances

$${σ}_{{r}_{n}}^{2}$$

on the Latent observations rₙ and the hyperparameter T can be inserted into conventional Bayesian aggregation equations

$${σ}_{z}^{2} = {[ {( {σ}_{z , 0}^{2} )}^{- 1} + {\sum }_{n = 1}^{N} {( {σ}_{{r}_{n}}^{2} )}^{- 1} ]}^{- 1}$$

$${μ}_{z} = {μ}_{z , 0} + {\sum }_{n = 1}^{N} \frac{{r}_{n} - {μ}_{z , 0}}{{σ}_{{r}_{n}}^{2}}$$

The resulting equations then form the softmax aggregation equations:

$${σ}_{z}^{2} = \frac{1}{{\sum }_{n = 1}^{N} exp ( \frac{{r}_{n}}{T} )}$$

$${μ}_{z} = \frac{{\sum }_{n = 1}^{N} {r}_{n} \cdot exp ( \frac{{r}_{n}}{T} )}{{\sum }_{n = 1}^{N} exp ( \frac{{r}_{n}}{T} )}$$

For the resulting equations, it is assumed that μ_{z,0}=0 and σ_{z,0}→∞.

The use of the additional trainable hyperparameter T makes so-called softmax aggregation possible, which can replace conventional aggregation methods, such as mean aggregation, max aggregation, or Bayesian aggregation, in neural-process-based architectures. It may be advantageous that the softmax aggregation combines the traditional mean aggregation and max aggregation: The mean aggregation is restored at the limit T_{→}^{∞} and the max aggregation at the limit T_{→}0.

The method furthermore comprises a step 120, wherein the latent Gaussian distribution is parameterized by the variance σ_{z}² and the mean μ_{z} in step 120.

According to one embodiment, the latent observations rₙ are generated by mapping context data pairs xₙ, yₙ by means of a neural encoder network to a corresponding latent observation rₙ, cf. step 130. Subsequently,

$${σ}_{z}^{2}$$

and μ_{z} are calculated according to the described equations, cf. step 110, and the latent Gaussian distribution is parameterized with these parameters, cf. step 120.

The hyperparameter is, for example, determined in a training and/or optimization method preceding the method 100, cf. step 140. It may be provided that the hyperparameter T is generated by means of the neural encoder network in order to map the context data pairs xₙ, yₙ. For example, it may be advantageous if the hyperparameter T is learned together with parameters of the neural encoder network in order to map the context data pairs xₙ, yₙ, for example in a common learning process. According to a further embodiment, the hyperparameter T is determined independently through hyperparameter optimization.

According to a further embodiment, a variance of an output of the model, also output variance σ_{y}², is determined on the basis of the latent Gaussian distribution, in particular on the basis of an input point x and on the basis of a latent sample z derived from the Gaussian distribution, by means of a neural decoder network, cf. step 150. The neural decoder network can thus calculate predictions about target variables y at locations x on the basis of samples z from the latent Gaussian distribution.

According to a further embodiment, a mean μ_{y} of the output of the model is determined on the basis of the latent Gaussian distribution, in particular on the basis of an input point x and on the basis of a latent sample z derived from the Gaussian distribution, by means of a further neural decoder network, cf. step 150. The mean μ_{y}, in particular in combination with the output variance, provides an estimate of target variables y.

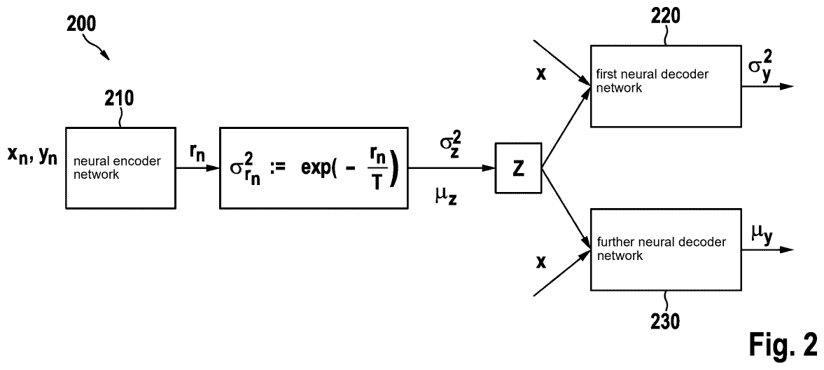

FIG. 2 shows an architecture of a neural network 200, in particular a neural process, wherein the neural network 200 is designed to perform steps of a method 100 according to the described embodiments for assessing uncertainties in a model, wherein the model models a technical system and/or system behavior of the technical system.

According to FIG. 2, the neural network 200 comprises a neural encoder network 210. The neural encoder network 210 is trained to generate the latent observations rₙ by mapping context data pairs xₙ, yₙ to a corresponding latent observation rₙ.

According to FIG. 2, the neural network 200 comprises a first neural decoder network 220, wherein the first neural decoder network 220 is trained to determine the variance of an output of the model, also output variance σ_{y}², on the basis of an input point x and a latent sample z.

According to FIG. 2, the neural network 200 comprises a further neural decoder network 230, wherein the further neural decoder network 230 is trained to determine a mean μ_{y} of the output on the basis of an input point x and a latent sample z. The mean μ_{y}, in particular in combination with the output variance, provides an estimate of target variables y.

Further embodiments relate to the use of the method 100 according to the described embodiments and/or of a neural network 200, in particular of a neural process, with an architecture according to the described embodiments, for ascertaining an in particular impermissible deviation of system behavior of a technical system from a standard value range.

An artificial neural network supplied with input data and output data of the technical device in a learning phase is useful when ascertaining the deviation of the technical system. Through the comparison with the input data and output data of the technical system, the corresponding connections are created in the artificial neural network and the neural network is trained on the system behavior of the technical system.

A plurality of training data sets used in the learning phase may comprise input variables measured on the technical system and/or calculated for the technical system. The plurality of training data sets may contain information relating to operating states of the technical system. Additionally or alternatively, the plurality of training data sets may contain information regarding the environment of the technical system. In some examples, the plurality of training data sets may contain sensor data. The computer-implemented machine learning system may be trained for a certain technical system in order to process data (e.g., sensor data) produced in this technical system and/or in its environment and to calculate one or more relevant output variables for monitoring and/or controlling the technical system. This may happen during the design of the technical system. In this case, the computer-implemented machine learning system can be used to calculate the corresponding output variables depending on the input variables. The data obtained can then be entered into a monitoring and/or control device for the technical system. In other examples, the computer-implemented machine learning system may be used during operation of the technical system in order to perform monitoring and/or control tasks.

In a prediction phase following the learning phase, the system behavior of the technical system can be reliably predicted by means of the neural network. For this purpose, in the prediction phase, input data of the technical system are supplied to the neural network, and output comparison data are calculated in the neural network and are compared with output data of the technical system. If this comparison shows that the output data of the technical system, which are preferably recorded as measured values, deviate from the output comparison data of the neural network and the deviation exceeds a limit value, there is an impermissible deviation of the system behavior of the technical system from the standard value range. Appropriate measures can then be taken, for example a warning signal can be generated or stored or partial functions of the technical system can be deactivated (degradation of the technical device). If necessary, alternative technical devices may be used in the event of an impermissible deviation.

Using the method described above, a real technical system can be continuously monitored. During the learning phase, the neural network is fed with sufficient information about the technical system from both the input side and the output side thereof, so that the technical system can be mapped and simulated in the neural network with sufficient accuracy. This makes it possible in the subsequent prediction phase to monitor the technical system and to predict a deterioration in the system behavior. In this way, the remaining service life of the technical system can in particular be predicted.

Specific forms of application relate, for example, to applications in various technical devices and systems. For example, computer-implemented machine learning systems can be used to control and/or monitor a device.

A first example relates to the design of a technical device or of a technical system. In this context, the training data sets may contain measurement data and/or synthetic data and/or software data that play a role in the operating states of the technical device or of a technical system. The input data or output data may be state variables of the technical device or of a technical system and/or control variables of the technical device or of a technical system. In one example, creating the computer-implemented probabilistic machine learning system (e.g., a probabilistic regressor or classifier) may comprise mapping an input vector of one dimension ( [symbol] ) to an output vector of a second dimension ( [symbol] ). Here, for example, the input vector may represent elements of a time series for at least one measured input state variable of the device. The output vector may represent at least one estimated output state variable of the device that is predicted on the basis of the generated a posteriori predictive distribution. In one example, the technical device may be a machine, for example an engine (e.g., an internal combustion engine, an electric motor, or a hybrid engine). In other examples, the technical device may be a fuel cell. In one example, the measured input state variable of the device may comprise a rotational speed, a temperature, or a mass flow. In other examples, the measured input state variable of the device may comprise a combination thereof. In one example, the estimated output state variable of the device may comprise a torque, an efficiency, a pressure ratio. In other examples, the estimated output state variable may comprise a combination thereof.

The various input variables and output variables in a technical device may exhibit complex nonlinear dependencies during operation. In one example, the computer-implemented machine learning systems of this disclosure may be used to model a parameterization of a characteristic map for the device (e.g., for an internal combustion engine, an electric motor, a hybrid engine, or a fuel cell). The modeled characteristic map of the method according to the present invention makes it possible, above all, to provide the correct relationships between the various state variables of the device quickly and accurately during operation. For example, during operation of the device (e.g., the engine), the characteristic map modeled in this way may be used to monitor and/or control the engine (e.g., in an engine control device). In one example, the characteristic map can indicate how dynamic behavior (e.g., energy consumption) of a machine (e.g., an engine) depends on various state variables of the machine (e.g., rotational speed, temperature, mass flow, torque, efficiency, and pressure ratio).

The computer-implemented machine learning systems can be used for the classification of a time series, in particular the classification of image data (i.e., the technical device is an image classifier). The image data may, for example, be camera data, lidar data, radar data, ultrasound data, or thermal image data (e.g., generated by corresponding sensors). In some examples, the computer-implemented machine learning systems may be designed for a monitoring device (e.g., of a production process and/or for quality assurance) or for a medical imaging system (e.g., for interpreting diagnostic data) or may be used in such a device.

In other examples (or additionally), the computer-implemented machine learning systems may be designed or used to monitor the operating state and/or the environment of an at least partially autonomous robot. The at least partially autonomous robot may be an autonomous vehicle (or another at least partially autonomous means of locomotion or transport). In other examples, the at least partially autonomous robot may be an industrial robot. For example, by using data from position sensors and/or velocity sensors and/or torque sensors, in particular of a robot arm, a precise probabilistic estimate of position and/or velocity, in particular of the robot arm, can be determined by means of the described regression. In other examples, the technical device may be a machine or a group of machines (e.g., an industrial plant). For example, an operating state of a machine tool can be monitored. In these examples, the output data y may contain information regarding the operating status and/or the environment of the corresponding technical device.

In further examples, the system to be monitored may be a communication network. In some examples, the network may be a telecommunication network (e.g., a 5G network). In these examples, the input data x may contain utilization data in nodes of the network, and the output data y may contain information regarding the allocation of resources (e.g., channels, bandwidth in channels of the network, or other resources). In other examples, a network malfunction may be detected.

In other examples (or additionally), the computer-implemented machine learning systems may be designed or used to control (or regulate) a technical device. The technical device may in turn be one of the devices discussed above (or below) (e.g., an at least partially autonomous robot or a machine). In these examples, the output data y may contain a control variable of the corresponding technical system.

In still other examples (or additionally), the computer-implemented machine learning systems may be designed or used to filter a signal. In some cases, the signal may be an audio signal or a video signal. In these examples, the output data y may contain a filtered signal.

The methods for creating and applying computer-implemented machine learning systems of the present disclosure may be performed on a computer-implemented system. The computer-implemented system may comprise at least one processor, at least one memory (which may contain programs that, if executed, perform the methods of the present disclosure) as well as at least one interface for inputs and outputs. The computer-implemented system may be a stand-alone system or a distributed system that communicates via a network (e.g., the Internet).

The present disclosure also relates to computer-implemented machine learning systems generated using the methods of the present disclosure. The present disclosure also relates to computer programs configured to perform all steps of the methods of the present disclosure. In addition, the present disclosure relates to machine-readable storage media (e.g., optical storage media or read-only memories, e.g., FLASH memories) on which computer programs configured to perform all steps of the methods of the present disclosure are stored.

1-11. (canceled)

12. A computer-implemented method for assessing uncertainties using a neural network, including a neural process, in a model, wherein the model models a technical system and/or system behavior of the technical system, the method comprising the following steps:
determining a model uncertainty as a variance of a latent Gaussian distribution and a mean of the latent Gaussian distribution, based of a number N of latent observations (rₙ), with n=1 . . . N, wherein the model uncertainty and the mean are determined depending on the latent observations (rₙ) and a hyperparameter; and
parameterizing the latent Gaussian distribution by the variance and the mean.

13. The method according to claim 12, wherein the latent observations (rₙ) are generated by mapping context data pairs (xₙ, yₙ) to a corresponding latent observation (rₙ) using a neural encoder network.

14. The method according to claim 13, wherein the hyperparameter is generated using the neural encoder network in order to map the context data pairs (xₙ, yₙ).

15. The method according to claim 12, wherein the hyperparameter is learned together with parameters of the neural encoder network in order to map the context data pairs (xₙ, yₙ).

16. The method according to claim 12, wherein the hyperparameter is determined independently through hyperparameter optimization.

17. The method according to claim 12, wherein a variance of an output of the model is determined based on the latent Gaussian distribution, including base on an input point and based on a latent sample derived from the Gaussian distribution, by means of a first neural decoder network.

18. The method according to claim 12, wherein a mean of an output of the model is determined based on the latent Gaussian distribution, including based on an input point and based on a latent sample derived from the Gaussian distribution, using a further neural decoder network.

19. An architecture of a neural network including a neural process, wherein the neural network is configured to assess uncertainties in a model, the neural network configured to:
determine a model uncertainty as a variance of a latent Gaussian distribution and a mean of the latent Gaussian distribution, based of a number N of latent observations (rₙ), with n=1 . . . N, wherein the model uncertainty and the mean are determined depending on the latent observations (rₙ) and a hyperparameter; and
parameterize the latent Gaussian distribution by the variance and the mean;
wherein the model models a technical system and/or system behavior of the technical system.

20. The architecture according to claim 19, wherein the neural network includes at least one neural encoder network and/or at least one neural decoder network, wherein the neural encoder network is trained to generate latent observations (rₙ) based on context data pairs (xₙ, yₙ), and/or the neural decoder network is trained to determine a variance of an output of the, and/or a mean of the output of the model based on the latent Gaussian distribution.

21. A device comprising:
a neural network including a neural process, the neural network having an architecture, the neural network being configured to assess uncertainties in a model, the neural network configured to:
determine a model uncertainty as a variance of a latent Gaussian distribution and a mean of the latent Gaussian distribution, based of a number N of latent observations (rₙ), with n=1 . . . N, wherein the model uncertainty and the mean are determined depending on the latent observations (rₙ) and a hyperparameter; and
parameterize the latent Gaussian distribution by the variance and the mean;
wherein the model models a technical system and/or system behavior of the technical system.

22. The method according to claim 12, wherein the method is configured to ascertain an impermissible deviation of the system behavior of the technical system from a standard value range.
